(19) United States
(12) Patent Application Publication
(10) Pub. No.: US 2020/0198076 A1
(43) Pub. Date: Jun. 25, 2020

(54) WOOD-PROCESSING SYSTEM AND WOOD-PROCESSING METHOD

(71) Applicant: IMA Schelling Deutschland GmbH, Lübbecke (DE)

(72) Inventor: Dirk Niebur, Hüllhorst (DE)

(73) Assignee: IMA Schelling Deutschland GmbH, Lübbecke (DE)

(21) Appl. No.: 16/629,451

(22) PCT Filed: Jul. 24, 2018
(86) PCT No.: PCT/EP2018/069975

§ 371 Date: Jan. 8, 2020

(30) Foreign Application Priority Data
Jul. 25, 2017 (DE) 102017116838.9

(51) Int. Cl. B23Q 7/04; B27M 1/08; B23Q 7/10

(52) U.S. Cl. CPC B23Q 7/046; B23Q 7/103; B27M 1/08

(57) ABSTRACT

A wood-processing system having a buffer, which receives and buffers planar workpieces of wood materials or wood substitute materials, and a deposit device, onto which workpieces removed from the buffer can be deposited. At least one robot is included to remove the workpieces from the buffer and to deposit said workpieces on a deposit element of the deposit device and/or at another deposit location in the buffer.

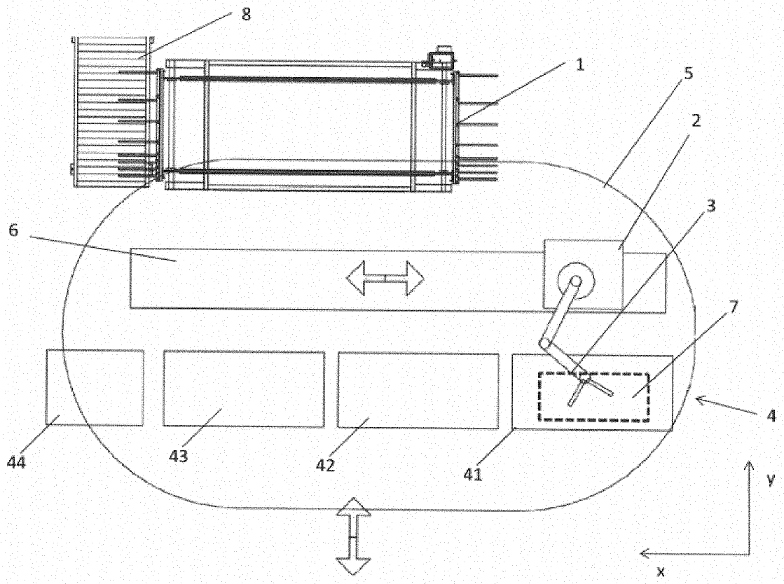

### CROSS REFERENCE TO RELATED APPLICATIONS

This patent application is the US National Phase of and claims priority on and the benefit of International Application No. PCT/EP2018/069975 having an international filing date of 24 Jul. 2018, which claims priority on and the benefit of German Patent Application No. 10 2017 116 838.9 having a filing date of 25 Jul. 2017.

### BACKGROUND OF THE INVENTION

### Technical Field

The invention relates to a wood-processing system and to a wood-processing method which can be carried out using a wood-processing system of this type.

### Prior Art

In wood-processing methods in which planar workpieces made of wood or wood-substitute materials are processed, the workpieces pass through a whole range of processing steps in the process. In this process, it is particularly important for workpieces that are undergoing processing to be fed to a buffer where necessary and to be buffered there until they are either fed to another processing step or, alternatively, to picking or quality control. For picking or quality control, the workpieces must be removed from the buffer and deposited according to predetermined sorting or a predetermined order. Depending on the size of the workpieces, very high personnel costs are incurred thereby.

### BRIEF SUMMARY OF THE INVENTION

The problem addressed by the present invention is to provide a wood-processing system and a wood-processing method by means of which the personnel costs can be reduced.

This problem is solved by a wood-processing system comprising a buffer which receives and buffers planar workpieces made of wood or wood-substitute materials, a depositing device on which workpieces removed from the buffer can be deposited, and at least one robot which is configured to remove the workpieces from the buffer and to deposit said workpieces on a deposit means of the depositing device and/or at another deposit point in the buffer, and by a wood-processing method in which planar workpieces made of wood or wood-substitute material are guided and/or processed in a wood-processing system, wherein workpieces are fed to a buffer and are buffered therein, wherein buffered workpieces are further removed from the buffer by a robot in accordance with control criteria and are deposited in a predetermined deposit position in a depositing device that is separate from the buffer or in another deposit position in the buffer itself. Advantageous embodiments are found in the dependent claims.

The wood-processing system according to the invention comprises a buffer that receives and buffers planar workpieces made of wood or wood-substitute materials. Furthermore, the wood-processing system has a depositing device on which workpieces removed from the buffer can be deposited. According to the invention, at least one robot is also provided and is configured to remove the workpieces from the buffer and deposit said workpieces on a deposit means of the depositing device and/or at another deposit point in the buffer.

The use of at least one robot provides a whole range of advantages.

First of all, the workpieces removed from the buffer can be deposited in an accurate position in a significantly shorter time than is possible manually. It is also possible to re-sort the workpieces in the buffer, even if the buffer is designed to be movable, for example. By means of the robot, workpieces can be removed from the buffer at any time and fed to quality assurance or picking, for example. Workpieces can also be returned to the buffer. In addition, the use of the robot provides greater flexibility in terms of the design of the buffer and the orientation of the workpieces in the buffer and/or on the deposit means. By using a robot, unlike for simple discharge, the workpieces can be oriented in any manner on the deposit means, for example horizontally, vertically, or obliquely. Likewise, the workpieces can be oriented in any manner in the buffer, since the robot is capable of cooperating both with moving and idle buffers and of removing workpieces from the buffers or inserting said workpieces into the buffers.

The buffer is preferably supplied from an ongoing process. For this purpose, the wood-processing system may for example comprise a processing center and/or a processing circuit and/or a sawing device and/or a through-feed processing machine, from which workpieces enter the buffer. For this purpose, it may in particular be provided that the wood-processing system according to the invention comprises a feed device which feeds workpieces to the buffer. The feed may be sequential, but a plurality of workpieces may also be fed to the buffer simultaneously.

In addition, different deposit means may also be provided in the depositing device depending on the intended application. In particular, according to an advantageous embodiment of the present invention, the depositing device may comprise stationary deposit means, in particular pallets and/or a shelf and/or movable deposit means, in particular belt conveyors and/or roller conveyors and/or brush carriages.

Particularly with respect to the picking of finished workpieces, the robot can also be used to apply protective material to individual workpieces. For this purpose, it may in particular be provided that the wood-processing system according to the invention comprises a storage means that can be reached by the robot and stores protective material, in particular protective paper, protective cardboard or protective film.

The radius of action of the robot can be enlarged by the robot itself being movable at least along one axis. In this case, it may in particular be provided that the robot can be moved linearly, in particular in parallel with the depositing device, at least in a first direction, in particular on rails, in order to travel to deposit means arranged in succession in the first direction. In this way, the flexibility of the wood-processing system according to the invention is significantly increased. A second robot can also be provided which preferably is likewise movable along the same axis as the first robot. This can increase the cycle times, with the two robots also being able to perform different tasks.

According to another embodiment of the present invention, it may be provided that the workpieces can be moved in the buffer.

In terms of the method, the use of at least one robot provides a range of possibilities. According to a wood-processing method according to the invention in which planar workpieces made of wood or wood-substitute materials are guided and/or processing in a wood-processing system, workpieces are fed to the buffer and buffered therein. The buffered workpieces are further removed from the buffer by a robot in accordance with control criteria and are deposited in a predetermined deposit position in a depositing device that is separate from the buffer. Alternatively or additionally, the workpieces can also be deposited in another deposit position in the buffer itself instead of being deposited on the separate depositing device. On one hand, therefore, workpieces can be deposited for discharge, picking or quality assurance, and on the other hand it is possible to re-sort the buffer, i.e. to change the order of the workpieces in the buffer.

According to a preferred variant, the robot, after depositing a workpiece on a deposit means, receives a protective material, in particular protective paper, protective cardboard or protective film, from a storage means and then applies it to said deposited workpiece.

It may also preferably be provided that the robot is moved linearly along the depositing device in a first direction. In this way, it is possible to load the deposit means of a moving or stationary depositing device in succession.

### BRIEF DESCRIPTION OF THE DRAWING

The invention will be explained in greater detail in the following with reference to the FIGURE of the drawings.

Said FIGURE is a schematic plan view of at least part of a wood-processing system according to the invention.

### DETAILED DESCRIPTION OF PREFERRED EMBODIMENTS

The FIGURE shows a buffer 1 in which workpieces are buffered which enter the buffer 1 by means of a feed apparatus 8. The buffer 1 may be designed such that it retains the workpieces in a horizontal manner. Alternatively, it is equally possible to use the feed apparatus 8 to load a buffer 1 which retains the workpieces in a vertical orientation (i.e. perpendicular to the floor).

A depositing device 4 is arranged opposite the buffer 1 and, in the example shown, comprises a plurality of deposit means 41, 42, 43, 44 on which workpieces 7 can be deposited. As indicated in the example shown, the depositing device 4 may be a stationary apparatus. It is equally possible to use a conveying apparatus as a depositing device, for example, which e.g. conveys the workpieces 7 in the direction X and/or Y or also in a circle. According to the invention, the robot 2 is arranged between the buffer 1 and the depositing device 4, and said robot has a robot arm 3 by means of which a workpiece 7 can be gripped. In the example shown, the robot 2 is mounted on a guide apparatus 6, which may be a rail, for example. The robot is movable on the guide apparatus 6 in the direction X in parallel with the depositing device 4. In this way, the robot 2 can travel to the deposit means 41 to 44 of the depositing device 4 and workpieces 7 can be deposited thereon and/or removed from said deposit means. The range of action of the robot 2 is indicated by the line 5. The robot 2 is therefore capable of traveling to any point within the line 5. The workpieces which enter the buffer 1 by means of the feed apparatus 8 are removed from the buffer 1 by means of the robot 2 and are either deposited again at another point in the buffer 1 or are transported by the robot 2 to a deposit means 41 to 44 of the depositing device 4 and are deposited there. Likewise, workpieces 7 that are deposited on one of the deposit means 41 to 44 can be removed by the robot 2 and, for example, brought back into the buffer 1. It is also possible for the robot 2 to remove a protective material from a protective material from a protective-material store (not shown) and apply it to a workpiece 7 positioned on the deposit means 41 to 44.

1. A wood-processing system comprising a buffer (1) which receives and buffers planar workpieces (7) made of wood or wood-substitute materials, a depositing device (4) on which workpieces (7) removed from the buffer (1) can be deposited, and at least one robot (2) which is configured to remove the workpieces (7) from the buffer (1) and to deposit said workpieces on a deposit means (41-44) of the depositing device (4) and/or at another deposit point in the buffer (1).

2. The wood-processing system according to claim 1, further comprising a feed device (8) which feeds the workpieces (7) to the buffer (1).

3. The wood-processing system according to claim 2, further comprising a processing circuit and/or a sawing device and/or a processing center arranged upstream of the feed device (8), from any of which the feed device (8) receives the workpieces (7) to be buffered.

4. The wood-processing system according to claim 1, wherein the depositing device (4) comprises stationary deposit means and/or movable deposit means (41-44).

5. The wood-processing system according to claim 1, further comprising a storage means that is reachable by the robot (2) and stores protective material.

6. The wood-processing system according to claim 1, wherein the at least one robot is movable linearly, at least in a first direction (X), in order to travel to deposit means (41-44) arranged in succession in the first direction (X).

7. The wood-processing system according to claim 1, wherein the workpieces (7) are moved in the buffer (7).

8. A wood-processing method in which planar workpieces (7) made of wood or wood-substitute material in a wood-processing system, comprising feeding workpieces (7) to a buffer (1) and buffering the workpieces (7) in the buffer (1), removing buffered workpieces (7) from the buffer (1) by a robot (2) in accordance with control criteria, and depositing the buffered workpieces (7) in a predetermined deposit position in a depositing device (4) that is separate from the buffer (1) or in another deposit position in the buffer (1) itself.

9. The wood-processing method according to claim 8, in which the robot (2), after depositing a workpiece (7) on a deposit means (41-44), receives a protective material from a storage means and applies it to said workpiece (7).

10. The wood-processing method according to claim 8, wherein the robot (2) is moved linearly along the depositing device (4) in a first direction (X).

11. The wood-processing method according to claim 9, wherein the robot (2) is moved linearly along the depositing device (4) in a first direction (X).

12. The wood-processing method according to claim 9, wherein the protective material is selected from the group consisting of protective paper, protective cardboard, and protective film.

13. The wood-processing method according to claim 11, wherein the protective material is selected from the group consisting of protective paper, protective cardboard, and protective film.

14. The wood-processing system according to claim 2, wherein the feed device (8) feeds the workpieces (7) to the buffer (1) sequentially.

15. The wood processing system according to claim 4, wherein the stationary deposit means is selected from the group consisting of pallets and shelves.

16. The wood-processing system according to claim 4, wherein the movable deposit means is selected from the group consisting of belt conveyors, roller conveyors, and brush carriages.

17. The wood-processing system according to claim 5, wherein the protective material is selected from the group consisting of protective paper, protective cardboard, and protective film.

18. The wood-processing system according to claim 6, wherein the at least one robot is movable linearly in parallel with the depositing device (4).

19. The wood-processing system according to claim 6, wherein the at least one robot is movable linearly on rails.
